(19) United States
(12) Patent Application Publication
(10) Pub. No.: US 2026/0169828 A1
(43) Pub. Date: Jun. 18, 2026

(54) INTELLIGENT RESOURCE AND THERMAL MANAGEMENT USING ARTIFICIAL INTELLIGENCE FOR PERFORMANCE OPTIMIZATION

(71) Applicant: NVIDIA Corporation, Santa Clara, CA (US)

(72) Inventors: Rahul SINGH, Pune (IN); Abhilekh Krishnakumar TIWARI, Pune (IN)

(73) Assignee: NVIDIA Corporation, Santa Clara, CA (US)

(21) Appl. No.: 18/978,954

(22) Filed: Dec. 12, 2024

(51) Int. Cl. G06F 9/50; G06N 3/0455

(52) U.S. Cl. CPC G06F 9/5094; G06N 3/0455

(57) ABSTRACT

Various examples, systems, and methods are disclosed relating to resource and thermal management. A first computing system can obtain, from at least one monitor of at least one processing unit of or associated with the one or more processors, data corresponding to at least one metric of the at least one processing unit. The first computing system further can determine, using at least one artificial intelligence (AI) model, a predicted state of the at least one processing unit based at least on the at least one metric. The first computing system further can update, using the predicted state, at least one static data structure corresponding with a hardware configuration of the at least one processing unit to adjust resource management of the at least one processing unit for execution of a processing task by the at least one processing unit.

### BACKGROUND

Managing resource allocation and thermal conditions in systems with multiple processing units presents challenges. Some traditional methods rely on static configurations and predefined thresholds for task scheduling and thermal management, leading to inefficiencies and reduced adaptability. This approach can result in reduced system performance and increased energy consumption. Current systems are inadequate at dynamically adapting to operational changes, such as variations in workloads or thermal conditions, without relying on static thresholds. Additionally, traditional methods are often restricted in processing diverse operational metrics in real-time, reducing the capability of the systems to respond to varying operational demands. This approach can result in redundant processing and an inability to handle variable workloads in systems with multiple components (e.g., integrated GPUs (iGPUs), discrete GPUs (dGPUs), CPUs, and other components). Challenges in integrating dynamic resource management and thermal control mechanisms create inefficiencies, affecting the accuracy and computational efficiency of system operations in dynamic, multi-component environments (e.g., real-time or near real-time applications).

### SUMMARY

Implementations of the present disclosure relate to systems and methods for improving resource and thermal management in systems using one or more models. Systems and methods are disclosed that can utilize artificial intelligence (AI) and/or machine-learning (ML) models (e.g., variational autoencoders (VAEs), neural networks, machine learning-based regression models, and/or any predictive learning models) and/or real-time monitoring (e.g., metrics of one or more processing units) and predictive analytics (e.g., predicted states) to improve the operational states of system components. The AI and/or ML models and metrics can be used to improve energy efficiency by dynamically updating resource management (e.g., updating parameters, performing thermal management tasks, allocating processing tasks, performing power management tasks, updating a static data corresponding with a hardware configuration and/or any hardware or component control tasks) based on the predicted states. That is, the predicted states can be future workload spikes, thermal conditions, energy usage patterns, performance bottlenecks, cooling demands, hardware utilization levels, and/or any system or component metrics. For example, systems and methods in accordance with the present disclosure can obtain operational metrics from system components, determine predicted operational states, and update task scheduling, thermal management operations, and/or kernel-level resource distribution to maintain and/or improve system performance.

Additionally, the systems and methods can process operational metrics, such as performance requirements, thermal conditions, and/or energy consumption, to improve resource allocation and prevent and/or reduce operational thresholds from being exceeded. By predicting operational states based on at least these metrics, the systems and methods can adjust system parameters, such as clock speeds, power states, voltage levels, processor allocations, hardware frequencies, and/or cooling system settings, to improve system operations while reducing energy consumption. In some implementations, system updates allow the system to adapt to changing workload conditions in real-time (or near real-time) without requiring and/or using predefined thresholds or manual configuration. The dynamic adaptation process can improve the performance and efficiency of resource and thermal management systems across diverse operational conditions.

Some implementations relate to a system, including one or more processors. The one or more processors obtain, from at least one monitor of at least one processing unit of or associated with the one or more processors, data corresponding to at least one metric of the at least one processing unit. The one or more processors determine, using at least one artificial intelligence (AI) model, a predicted state of the at least one processing unit based at least on the at least one metric. The one or more processors update, using the predicted state, at least one static data structure corresponding with a hardware configuration of the at least one processing unit to adjust resource management of the at least one processing unit for execution of a processing task by the at least one processing unit.

In some implementations, the at least one processing unit includes at least one integrated graphics processing unit (iGPU) and at least one discrete graphics processing unit (dGPU), and updating the resource management includes allocating a plurality of processing tasks between the iGPU and the dGPU based on the predicted state of the at least one processing unit. In some implementations, the one or more processors update the at least one AI model using performance feedback data obtained from the at least one monitor. In some implementations, the at least one AI model includes a variational autoencoder (VAE).

In some implementations, the one or more processors establish at least on real-time communication channel with at least one kernel component of a kernel via a kernel level interface. In some implementations, the one or more processors use at least one communication protocol with the kernel level interface to transmit at least one parameter between a user space and kernel space. In some implementations, the one or more processors perform real-time communication with the kernel based at least on the real-time communication occurring within a predefined time window to synchronously update the at least one parameter. In some implementations, the one or more processors update the resource management on the at least one kernel component to cause an update of the at least one parameter before a component threshold is satisfied.

In some implementations, the one or more processors update the resource management by performing a thermal management task on at least one cooling system of the system based at least on the predicted state of the at least one processing unit. In some implementations, the one or more processors update the resource management by allocating the processing task on the at least one processing unit of the system based at least on the predicted state of the at least one processing unit. In some implementations, the one or more processors update the resource management by performing a power management task on at least one power management system of the system based at least on the predicted state of the at least one processing unit.

In some implementations, updating the resource management includes updating the at least one static data structure. In some implementations, the one or more processors update the resource management and execute the processing task during runtime of the system. In some implementations, the predicted state of the at least one processing unit includes forecasting a future state prior to satisfying a condition. In some implementations, forecasting the future state includes identifying a potential event or workload spike of the at least one processing unit. In some implementations, the at least one AI model is configured to process the at least one metric corresponding to at least one of a performance requirement, thermal condition, or energy consumption of the at least one processing unit as input to cause the at least one AI model to output the predicted state.

Some implementations relate to one or more processors including one or more circuits. The one or more circuits monitor at least one processing unit of or associated with the one or more processors. The one or more circuits, responsive to monitoring, obtain data corresponding to at least one metric of the at least one processing unit. The one or more circuits determine, using at least one artificial intelligence (AI) model, a predicted state of the at least one processing unit based at least on the at least one metric. The one or more circuits update, according to the predicted state, resource management of the at least one processing unit for execution of a processing task by the at least one processing unit.

In some implementations, the at least one processing unit includes at least one integrated graphics processing unit (iGPU) and at least one discrete graphics processing unit (dGPU), and updating the resource management includes allocating a plurality of processing tasks between the iGPU and the dGPU based on the predicted state of the at least one processing unit. In some implementations, the one or more circuits update the at least one AI model using performance feedback data obtained from at least one monitor. In some implementations, the at least one AI model includes a variational autoencoder (VAE).

In some implementations, the one or more circuits establish at least on real-time communication channel with at least one kernel component of a kernel via a kernel level interface. In some implementations, the one or more circuits use at least one communication protocol with the kernel level interface to transmit at least one parameter between a user space and kernel space. In some implementations, the one or more circuits perform real-time communication with the kernel based at least one the real-time communication occurring within a predefined time window to synchronously update the at least one parameter. In some implementations, the one or more circuits update the resource management on the at least one kernel component to cause an update of the at least one parameter before a component threshold is satisfied.

In some implementations, the one or more circuits update the resource management by performing a thermal management task on at least one cooling system of the one or more processors based at least on the predicted state of the at least one processing unit. In some implementations, the one or more circuits update the resource management by allocating the processing task on the at least one processing unit of the one or more processors based at least on the predicted state of the at least one processing unit. In some implementations, the one or more circuits update the resource management by performing a power management task on at least one power management system of the one or more processors based at least on the predicted state of the at least one processing unit.

In some implementations, updating the resource management includes updating at least one static data structure corresponding with a hardware configuration of the at least one processing unit. In some implementations, the one or more circuits update the resource management and execute the processing task during runtime of the one or more processors. In some implementations, the predicted state of the at least one processing unit includes forecasting a future state prior to satisfying a condition. In some implementations, forecasting the future state includes identifying a potential event or workload spike of the at least one processing unit. In some implementations, the at least one AI model is configured to process the at least one metric corresponding to at least one of a performance requirement, thermal condition, or energy consumption of the at least one processing unit as input to cause the at least one AI model to output the predicted state.

Some implementations relate to a method. The method includes obtaining, by one or more processors using at least one artificial intelligence (AI) model, data from at least one monitor of at least one processing unit of or associated with the one or more processors, the data corresponding to at least one metric of the at least one processing unit. The method includes determining, by the one or more processors using the at least one AI model, a predicted state of the at least one processing unit based at least on the at least one metric. The method includes updating, by the one or more processors according to the predicted state, resource management of the at least one processing unit for execution of a processing task by the at least one processing unit.

The processors, systems, and/or methods described herein can be implemented by or included in at least one a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more multi-model language models, a system implementing one or more large language models (LLMs), a system implementing one or more small language models (SLMs), a system implementing one or more vision language models (VLMs), a system for generating synthetic data, a system for generating synthetic data using AI, a system incorporating one or more virtual machines (VMs), a system implemented at least partially in a data center, and/or a system implemented at least partially using cloud computing resources.

### BRIEF DESCRIPTION OF THE DRAWINGS

The present systems and methods for intelligent resource and thermal management using artificial intelligence for performance optimization are described in detail below with reference to the attached drawing figures, wherein:

FIG. 1 is a block diagram of an example of a system, in accordance with some implementations of the present disclosure;

FIG. 2 is a flow diagram of an example of a method for resource and thermal management in a resource management pipeline, in accordance with some implementations of the present disclosure;

FIG. 3A is a block diagram of an example generative language model system suitable for use in implementing at least some implementations of the present disclosure;

FIG. 3B is a block diagram of an example generative language model that includes a transformer encoder-decoder suitable for use in implementing at least some implementations of the present disclosure;

FIG. 3C is a block diagram of an example generative language model that includes a decoder-only transformer architecture suitable for use in implementing at least some implementations of the present disclosure;

FIG. 4 is a block diagram of an example computing device suitable for use in implementing at least some implementations of the present disclosure; and

FIG. 5 is a block diagram of an example data center suitable for use in implementing at least some implementations of the present disclosure.

### DETAILED DESCRIPTION

This disclosure relates to systems and methods for dynamic resource and thermal management of system components (e.g., processing units), such as systems and methods for improving component performance based on predicted states, energy consumption and/or workload distribution. Existing systems can present technical limitations in adapting to real-time workload and thermal variations, for example in systems that manage integrated GPUs (iGPUs) and discrete GPUs (dGPUs) under dynamic workloads. That is, iGPU and dGPU systems can be constrained by predefined operational thresholds, causing inefficiencies in energy consumption, overheating, or performance degradation. Static resource management models often utilize fixed configurations, such as predefined rules for task scheduling or thermal thresholds (e.g., static clock speeds, fixed cooling settings), resulting in limited adaptability and increased computational overhead. Additionally, resource management models can be technically limited by technical challenges related to integrating multiple metrics (operational metric—e.g., performance, thermal, and/or energy consumption metrics) while maintaining operational efficiency. That is, methods that use predefined thresholds or manual configurations often do not adapt effectively to real-time changes in performance demands and thermal conditions, particularly in systems that manage workloads with varying performance and thermal profiles.

Systems and methods in accordance with the present disclosure provide a computational framework for dynamic resource management that uses artificial intelligence (AI) model predictions and/or machine-learning models (e.g., variational autoencoder (VAE) predictions and/or neural network predictions). The VAE and/or neural network can process the metrics, encode patterns in the system performance data, and generate predictions corresponding to future states of the system components. By predicting states (operational states—e.g., future thermal conditions, performance demands, energy consumption, workload distribution, and/or other system metrics) the systems can update task scheduling, thermal management operations, and/or hardware controls in real-time (or near real-time). This can allow the AI-based framework to operate without predefined rules or static thresholds, continuously (or periodically) updating system parameters to improve performance, energy efficiency, and/or thermal stability. For example, the systems and methods can dynamically modify parameters such as, but not limited to, clock speeds, power states, voltage levels, processor core allocations, cooling system settings (e.g., fan speeds, liquid cooling rates), and/or any hardware performance settings based at least in part on predicted workload spikes, thermal events, and/or any operational changes.

In some implementations, the systems and methods can use at least one AI model and/or machine learning (ML) model (e.g., VAE and/or other neural networks) to obtain data from at least one monitor (e.g., monitoring device, sensors, and/or internal system monitors attached to various components (e.g., processing units) of the system, such as, but not limited to, temperature sensors, power sensors, utilization sensors) of at least one component (e.g., CPU, input, dGPU, memory units, network interfaces) of the system. That is, patterns can be encoded in system performance data based on learned (e.g., trained) operational behaviors and historical performance metrics. Additionally, the data can correspond to at least one metric (e.g., parameters measuring the state or behavior of the components, such as, but not limited to temperature, power draw, utilization, clock speed) of the component. Using the obtained data, the at least one AI and/or ML model can determine (e.g., cause a model to output and/or generate) a predicted state (e.g., operational state) of the at least one component. For example, the prediction can be based at least in part on the metric. In some implementations, the systems and methods can update (e.g., via an interface and in real-time or near real-time) at least one parameter associated with the component. For example, the updating can include performing at least one resource management operation to improve system performance.

In some implementations, the system can process metrics (e.g., performance requirements, thermal conditions, or energy consumption) to predict future operational states of components (e.g., CPUs, GPUs). That is, the predicted states can allow the system to optimize resource allocation before performance bottlenecks or overheating occur, minimizing (or reducing) inefficiencies in task distribution and thermal regulation. Additionally, the AI and/or ML model can be trained and/or re-trained continuously (or periodically) based on real-time system performance data and/or implemented updates to parameters. Thus, by continuously processing real-time operational metrics (e.g., CPU load, GPU temperature, power consumption, network activity, and/or any storage usage metrics), the AI and/or ML model can improve the resource management of the system.

In some implementations, the system can modify cooling system parameters (e.g., fan speeds, liquid cooling rates) based on predicted thermal conditions of the components. Additionally, the system can modify hardware parameters (e.g., such as GPU frequencies, voltage levels, or power states) based on predicted operational requirements. In some implementations, system configurations (e.g., static data structures corresponding to hardware configurations) can be dynamically modified during runtime. Accordingly, by reducing and/or eliminating static configurations and predefined thresholds, the disclosed systems and methods provide a real-time, adaptive technical solution for maintaining performance, energy efficiency, and thermal stability across diverse operational conditions.

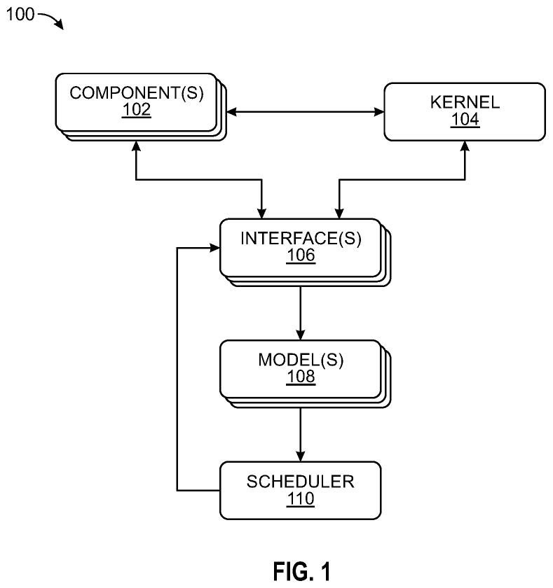

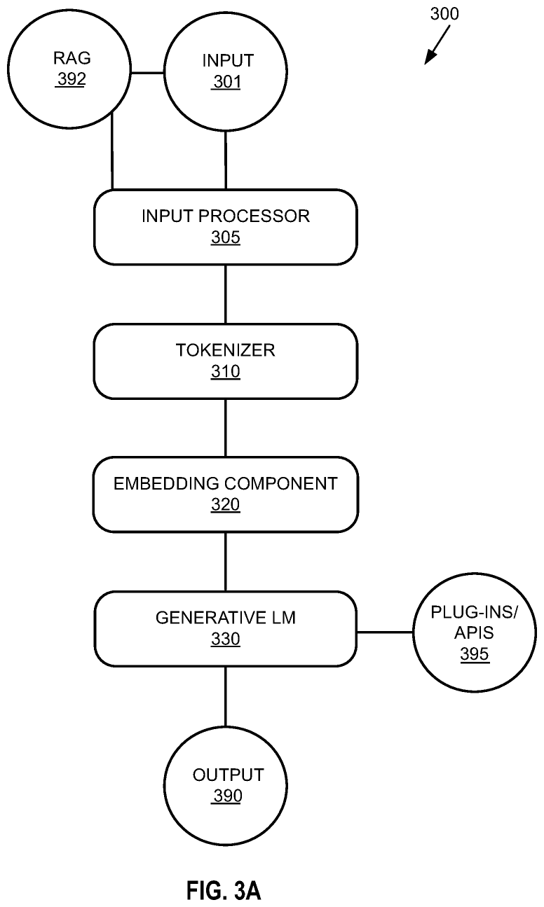

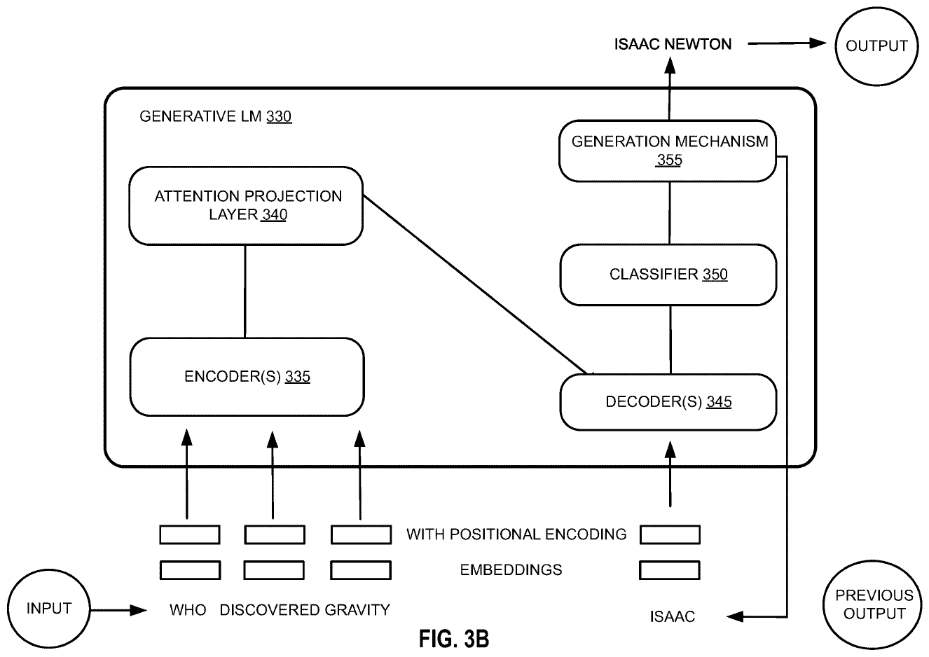

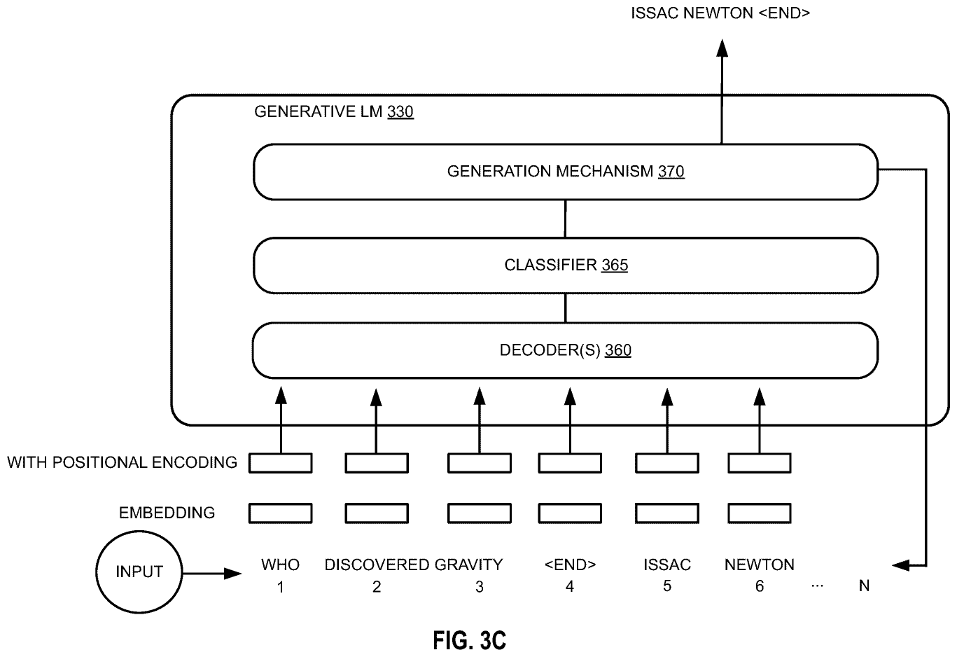

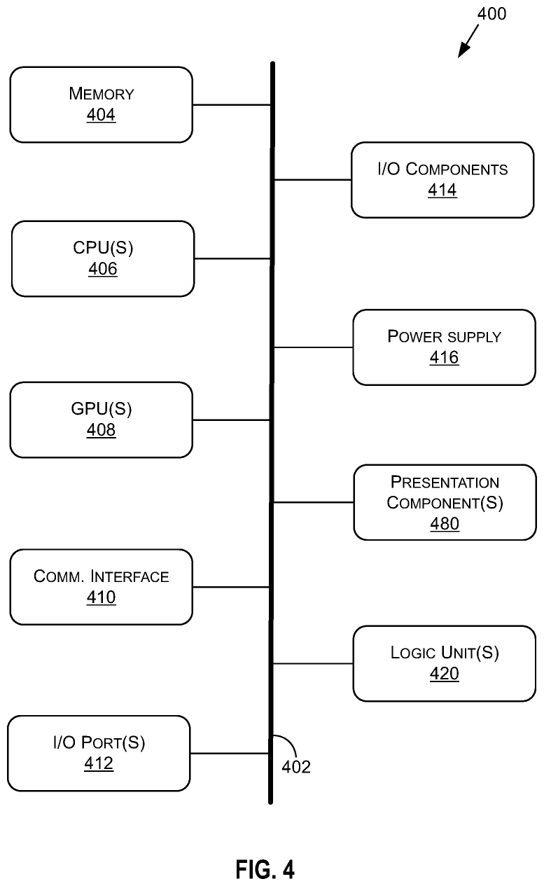

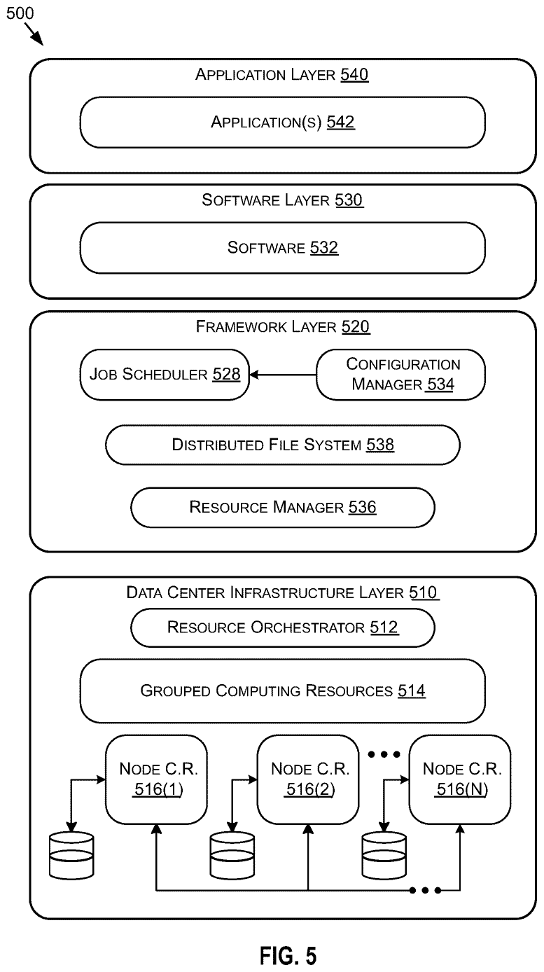

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 300 of FIG. 3A, example generative language model (LM) 330 of FIGS. 3B-3C, example computing device 400 of FIG. 4, and/or example data center 500 of FIG. 5.

The system 100 can implement at least a portion of a resource management pipeline, such as a thermal management pipeline, a task scheduling pipeline, and/or a power allocation pipeline. The system 100 can be used to update system parameters and/or predict operational states by any of various systems described herein, including but not limited to gaming systems, data center systems, high-performance graphical processing systems, edge computing systems, robotic systems, autonomous vehicle systems, medical device systems, industrial automation systems, augmented/virtual reality systems, and/or consumer electronics systems.

Referring briefly to FIG. 1, the resource management pipeline can include operations performed by the system 100. For example, the resource management pipeline can include any one or more of an interfacing stage, a modeling stage, and/or a scheduling stage. Each stage of the resource management pipeline includes one or more components of the system 100 that perform the functions described herein. In some implementations, one or more of the stages can be performed during the training of AI and/or ML models. Additionally, one or more of the stages can be performed during the inference phase using the AI and/or ML models.

Referring further to FIG. 1, the system 100 (e.g., implementing the resource management pipeline) can obtain, by at least one artificial intelligence (AI) model from at least one monitor of at least one processing unit of or associated with the one or more processors of the system 100, data corresponding to at least one metric of the at least one processing unit. In some implementations, implementing the resource management pipeline can include the system 100 determining, using the at least one AI and/or ML model, a predicted state of the at least one processing unit based at least on the at least one metric. Additionally, implementing the resource management pipeline can include the system 100 updating, according to the predicted state, resource management of the at least one processing unit for execution of a processing task by the at least one processing unit. This can allow the resource management pipeline to improve system performance, energy efficiency, and/or thermal stability.

In some implementations, the interfacing stage can be the stage in the resource management pipeline in which the system 100 can obtain data corresponding to at least one metric (e.g., operational parameters measuring the state or behavior of the components 102 and/or kernel 104, such as, but not limited to, temperature, power draw, utilization, clock speed, kernel thread states, resource allocation levels, latency metrics, etc.) of the at least one processing unit. The system 100 can include at least one interface 106. The interface 106 can interface and/or communicate with monitors (e.g., monitoring devices and/or sensors) of the component(s) 102 and kernel 104 to obtain data corresponding with metrics of a processing unit. That is, interfacing can include communicating with, transmitting data to, receiving data from, and/or communication according to a communication protocol, such as Netlink sockets, sysfs entries, input/output control (IOCTL) interfaces, and/or any kernel-level messaging frameworks. For example, the interface 106 can transmit requests for operational data. For example, during the interfacing stage, the interface 106 can query metrics from the kernel 104 related to thermal conditions and processing states. In another example, the interface 106 can poll monitoring devices of the components 102 for utilization data. For example, the interface 106 can transmit requests for operational data. For example, during the interfacing stage, the interface 106 can query metrics from the kernel 104 related to thermal conditions and processing states. In another example, the interface 106 can poll monitoring devices of the components 102 for utilization data.

In some implementations, the interface 106 can interface with monitors (e.g., using sysfs and/or procfs) to interface with the components 102. The component(s) 102 can be CPU, integrated graphics processing unit (iGPU), dGPU, memory units, network interfaces, storage devices, accelerators (e.g., AI accelerators or tensor processing units), peripheral devices, and/or any computational hardware components. That is, the CPU, GPUs (e.g., iGPU, dGPU, cloud GPUs, virtual GPUs (vGPU), external GPUs (eGPU), AI-specific GPUs (AIGPU), FGPA-based GPUs, custom GPUs), memory units, network interface, storage devices, accelerators (e.g., AI accelerators or tensor processing units), peripheral devices, and/or any computational hardware components can include one or more processing units. The processing units can be component(s) 102 configured and/or implemented to execute processing tasks and monitor operational states. That is, the processing units can support task scheduling, resource management, and/or thermal monitoring operations. For example, a dGPU can execute rendering tasks and report power draw and utilization metrics. The processing units can include one or more monitors. That is, the monitors of the components 102 can be monitoring device, sensors, and/or internal system monitors attached to and/or otherwise integrated into the various components (e.g., processing units) of the system 100. For example, the monitors can be temperature sensors, power sensors, utilization sensors, performance counters, thermal analysis devices, fan controllers, and/or power management units. In some examples, one or more device drivers can be used to facilitate the communications between the monitors and the interface 106. For example, a GPU driver can provide the interface 106 with access to performance counters and thermal sensors.

In some implementations, the interface 106 can interface with an iGPU by accessing a shared memory region managed by the CPU and GPU. For example, the interface 106 can obtain workload metrics from the iGPU through inter-process communication (IPC) mechanisms. In some implementations, the interface 106 can interface with a dGPU by querying driver-level APIs for thermal and utilization metrics. For example, the interface 106 can retrieve the dGPU clock speed and thermal state via the device driver. In some implementations, the interface 106 can interface with a CPU by issuing system calls to obtain power state and utilization data. For example, the interface 106 can retrieve CPU core frequencies and active thread counts through kernel-level monitoring APIs. Additionally, the interface 106 can interface with a cloud GPU by transmitting telemetry requests over a network to retrieve operational metrics. For example, the interface 106 can query the cloud GPU for resource allocation data and current processing load via a remote monitoring protocol. In some implementations, the interface 106 can interface with an AIGPU by accessing AI accelerator APIs for power and temperature metrics. For example, the interface 106 can obtain tensor core utilization and power draw from the AIGPU driver.

In some implementations, interfacing with the kernel 104 can include the interface 106 interfacing with monitors. The kernel 104 can be a program and/or loaded data package of the system 100 configured to manage resource allocation, process scheduling, and hardware abstraction. That is, the kernel 104 can facilitate communication and/or otherwise interface with one or more processing units (e.g., component(s) 102) using a module interface (e.g., to validate parameter updates and/or changes to prevent invalid configurations), a syscall interface, and/or a device driver framework. In some implementations, the kernel 104 can be interfaced with by the interface 106 using a kernel level interface (e.g., a Netlink socket for message transmission, sysfs entries for parameter adjustments, IOCTL interface for calling or interfacing one or more controls). For example, Netlink sockets can be used to transmit operational data from user-space processes to kernel-space modules in real-time or near-real-time. For example, custom IOCTLs can be used to execute control commands for updating component-specific parameters, such as power states or cooling settings. Additionally, while various outputs can be generated and/or resource management actions or tasks can be performed, the kernel 104 can, in some implementations, authenticate and validate some or all changes to the kernel 104 or directly on the components 102 by verifying the integrity of transmitted parameters using pre-configured validation rules or cryptographic signatures. For example, the kernel 104 of the system 100 can reject invalid or unsafe updates to component parameters, such as those exceeding predefined thermal or power limits, and log errors for further analysis.

Additionally, the monitors can be otherwise associated with one or more processors (or processing units) based on the kernel 104. That is, the associations can include hardware-specific mappings of monitors to kernel-managed data structures, allowing the kernel 104 to retrieve and process operational metrics (and otherwise provide data corresponding with the metrics) from the associated monitors. In some implementations, the interface 106 can use various mechanisms and/or protocols to request operational data or perform parameter updates (e.g., on-the-fly adjustments) and/or system updates. For example, the interface 106 can query kernel-managed power states or thermal thresholds for the components 102. The kernel 104 can interact and/or otherwise communicate with one or more monitors. In some examples, dedicated sensor chips or monitoring devices of the components 102 on the system 100 can be communicated with using device drivers. That is, the device drivers can translate hardware-level monitoring data into metrics accessible by the kernel 104. For example, the kernel 104 can use a thermal monitoring driver (e.g., device driver) to retrieve GPU temperature and thermal thresholds.

In some implementations, the interface 106 can interface (e.g., during the interfacing stage) with an iGPU through (or via) the kernel 104 by utilizing system-level APIs to access performance metrics and adjust resource allocations. For example, the interface 106 can retrieve power draw and utilization metrics of an iGPU via kernel data structures. In some implementations, the interface 106 can interface with a dGPU through the kernel 104 by using device-specific drivers (e.g., updated to accept updates from the model(s) 108 and/or scheduler 110) to manage clock speeds and voltage settings. For example, the interface 106 can access thermal and performance data from the dGPU via kernel-managed interfaces. In some implementations, the interface 106 can interface with a CPU through the kernel 104 by retrieving core utilization and thread scheduling data for workload distribution. For example, the interface 106 can determine existing (e.g., real-time or near real-time) task assignments of the CPU based on data received through kernel-level monitoring interfaces.

In some implementations, the metrics can be operational parameters measuring the state (e.g., temperature, power draw, voltage levels, utilization levels, and/or any operational thresholds) or behavior (e.g., task distribution, processing efficiency, thermal changes, workload patterns, and/or any dynamic performance variations) of the components 102 and/or kernel 104. That is, the operational parameters can be indicative of the current and predicted performance and thermal conditions of the components 102 and/or kernel 104. In some implementations, the model(s) 108 can obtain the data corresponding to the metrics using the interface(s) 106 communicating with and/or otherwise interfacing with the components 102 and/or kernel 104 via monitors. That is, the model(s) 108 can be executed and/or otherwise implemented to obtain data corresponding with the metrics as input to the model(s) 108. For example, the model(s) 108 can query the interface 106 to retrieve temperature or utilization data from memory locations updated by component sensors. In another example, the model(s) 108 can obtain clock speed or voltage levels by invoking system calls or device driver routines exposed by the interface 106. Additionally, obtaining the data can include the model(s) 108 requesting operational metrics from the kernel 104 through the interface 106 to ensure the data reflects real-time or near-real-time conditions.

In some implementations, the model(s) 108 obtain data corresponding to the metrics through execution of instructions by the one or more processors of the system 100. The model(s) 108 provide data access requests as instructions to the interface 106, which can facilitate the retrieval of metrics from monitoring devices of the components 102 and/or the kernel 104. For example, the instructions executed by the processors can invoke system calls, device driver functions, or read operations on memory-mapped data structures associated with the interface 106 (e.g., hardware registers, shared memory buffers, sysfs entries). In some implementations, the interface 106 can process these requests to access data stored in kernel-managed monitoring subsystems or directly in the monitoring devices or sensors. That is, the model(s) 108 can define metrics (e.g., temperature, utilization, power draw, voltage levels) as input parameters.

In some implementations, the parameters can be mapped to system-level commands executed by the processors, which can communicate with the interface 106 to access the corresponding data. For example, the interface 106 can relay a request to a kernel module validating updates or changes to prevent invalid configuration that could harm the system 100 and/or managing utilization counters or temperature sensors, retrieve the data from the monitoring device, and provide it to the processors executing the model(s) 108. In this example, a kernel module can be added (e.g., by modifying the configuration of the kernel 104 to load a new module during runtime via dynamic kernel module loading) and/or otherwise updated (e.g., by applying a kernel patch or recompiling the kernel with additional support for processing outputs of the model 108) to accept outputs of the model 108. In another example, the processors can access real-time (or near real-time) performance data by reading specific memory locations updated by kernel drivers through the interface 106. In some implementations, the interface 106 acts as an intermediary, translating data requests from the processors into hardware or kernel-level operations and providing the retrieved metrics to the model(s) 108 for use in modeling.

In some implementations, the modeling stage can be the stage in the resource management pipeline in which the system 100 can determine a predicted state (e.g., future state) of the at least one processing unit based at least on the at least one metric. The predicted state can be a forecasted representation of an operational condition of the at least one processing unit at a time subsequent to the time of the prediction. That is, the predicted state can be a set of values and/or conditions corresponding to operational parameters (e.g., temperature, power consumption, resource utilization, performance levels, clock speed, processing latency, thermal thresholds, and/or any hardware conditions) of the at least one processing unit and/or system component, forecasted (e.g., generated by an AI model such as a variational autoencoder (VAE) or neural network based on learned patterns in operational metrics and historical performance data) to occur at a future time (e.g., milliseconds, seconds, or minutes ahead) based on the input metric data and modeling. In some implementations, the model 108 can determine a future state of the at least one processing unit (e.g., an operational state of a component 102 before a condition occur) prior to an event occurring and/or satisfying a condition (e.g., temperature threshold, high power consumption, performance bottleneck). In some implementations, determining the predicted state can include the model 108 outputting and/or otherwise determining a potential event (e.g., thermal overload, power overdraw) or workload spike (e.g., sudden GPU demand, memory/CPU usage surge) of the at least one processing unit (e.g., the component 102). For example, the predicted state can be a state indicating if a component 102 is going to overheat, enter a high-power state, and/or experience performance throttling.

In some implementations, the system 100 can include at least one model 108. The model 108 can include any one or more artificial intelligence models (e.g., variational autoencoder (VAE), machine learning models, supervised models, neural network models, deep neural network models), rules, heuristics, algorithms, functions, or various combinations thereof to perform operations including predicting operational states, such as forecasting thermal conditions, workload spikes, or performance bottlenecks. That is, the model 108 can be a variational autoencoder (VAE) and/or neural network trained to model operational metrics to identify patterns that indicate potential future events or states. In some implementations, training can include using performance requirement, thermal condition, and/or energy consumption information of the at least one processing unit as input to cause the at least one AI and/or ML model to output the predicted state. The predicted state can be measured against operational metrics or pre-defined operational thresholds. That is, the model 108 can be trained by iteratively updating its weights and biases based on discrepancies between the predicted states and observed system performance metrics.

In some implementations, the system 100 can implement non-static device tree blocks (DTBs) that can be dynamically updated during runtime to modify hardware configurations (e.g., without requiring reboots of the system 100). The model 108 can generate outputs used by the scheduler 110 to update DTB parameters, such as GPU frequencies, power states, or voltage levels, based on predicted operational states. The DTBs can be stored in kernel-accessible memory locations and updated by the scheduler 110 using kernel-level interfaces (e.g., sysfs entries, IOCTL calls) to apply configuration changes dynamically. The model 108 can output updates for DTBs that can include modifying data structures that define hardware configurations (e.g., clock speeds, power limits, or device-specific operational parameters). In some implementations, the model 108 can output configuration changes based on predicted operational states, and the scheduler 110 can write these changes to the DTBs during system runtime. Additionally, the kernel 104 can validate the DTB updates using predefined constraints (e.g., thermal limits or voltage safety ranges) before applying the changes to prevent invalid configurations. In some implementations, the interface 106 can facilitate communication between the scheduler 110 and the kernel 104, allowing the updated DTBs to reconfigure hardware components, such as iGPUs, dGPUs, and CPUs, in real-time (or near real-time).

In some implementations, the model 108 can output a resource management action (e.g., to allocate processing tasks between an iGPU and a dGPU, to perform thermal management tasks, to allocate other processing tasks, to perform power management tasks, and/or any task scheduling or hardware control actions). For example, the model 108 can determine a reallocation of workloads between components to prevent a thermal threshold from being exceeded. In another example, the model 108 can output a command to adjust clock speeds or power states to improve energy consumption while maintaining system performance. In some implementations, the resource management action can be provided to the scheduler 110 to perform task distribution or parameter adjustments using the interface(s) 106, interfacing with the components 102 (e.g., via a component and/or hardware level interface) and/or kernel 104 (e.g., via a kernel level interface).

In some implementations, the at least one model 108 can maintain, execute, train, and/or update one or more VAEs and/or machine-learning models during the modeling stage. In some implementations, the VAE can include any type of unsupervised or semi-supervised machine-learning models capable of generating latent representations of system metrics (e.g., temperature distributions, workload patterns, utilization trends) to forecast operational states. Additionally, the VAE can be embedded in the operational loop of the system 100 such that it continuously processes real-time operational metrics to provide updated forecasts of future states to inform resource adjustments. That is, the resource management pipeline can include an embedded VAE and/or other machine learning model that can influence and/or otherwise adjust component 102 behavior and/or update system parameters (e.g., in real-time or near real-time). For example, the VAE can be trained and/or updated to identify potential workload spikes in the components 102 based on latent representations of utilization data, among other forecasting tasks, such as predicting energy consumption trends or thermal thresholds. Additionally, the machine-learning models can be or include a transformer-based model (e.g., a generative pre-trained transformer (GPT) model).

The model 108 can include at least one neural network. The model 108 can include an input layer, an output layer, and/or one or more intermediate layers, such as encoder layer, latent space layer, and/or decoder layer, which can each have respective nodes. That is, the model 108 can extract high-dimensional representations of operational data for forecasting purposes. For example, the input layer can receive raw data corresponding to operational metrics such as power draw, temperature, and workload distribution. For example, the output layer can generate predicted operational states such as potential workload surges or thermal thresholds being exceeded. For example, the intermediate layers process data to identify correlations between operational metrics and future performance states. In some examples, the encoder layer(s) of the intermediate layers can transform raw operational data into latent vectors representing compressed patterns of system behavior. In some implementations, the encoder layer can be a layer or layers in which input metrics are mapped into lower-dimensional latent spaces. In some examples, the latent space layer of the intermediate layers can store representations of patterns in operational metrics for forecasting. In some implementations, the latent space layer of the decoder layer(s) can be a layer in which a vector generated by the encoder layer can be used to reconstruct predicted operational states. That is, the latent space layer can be a layer or layers where patterns in operational metrics are represented in a form suitable for generating predictions. In some examples, the decoder layer of the intermediate layers can reconstruct predicted outputs from latent representations. In some implementations, the decoder layer can be a layer or layers in which latent patterns are translated into actionable predictions such as workload surges or thermal conditions.

In some implementations, the system 100 can configure (e.g., train, update, fine tune, apply transfer learning to) the model 108 by modifying or updating one or more parameters, such as weights and/or biases, of various nodes of the model 108 responsive to evaluating estimated outputs of the model 108 (e.g., generated in response to receiving training examples in a training dataset and/or otherwise provided from operational data collected from system components, kernel-level monitoring outputs, or simulated workloads). The model 108 can be or include various neural network models, including models that can operate on or generate predicted states of process units including but not limited to iGPUs, dGPUs, CPUs, memory units, storage devices, network interfaces, and/or accelerators.

In some implementations, the model 108 can be configured (e.g., trained, updated, fine-tuned, has transfer learning performed, etc.) based at least on the training data of the at least one training dataset. For example, one or more example operational metrics and/or observed performance conditions of processing units or hardware configurations of the training data can be applied (e.g., by the system 100, or in a pre-training process performed by the system 100 or another system) as input to the model 108 to cause the model 108 to generate an estimated output (e.g., determine a predicted state). The estimated output can be evaluated and/or compared with ground truth data (or reference conditions) of the training data that correspond with the one or more example observed performance metrics and/or system conditions of components and/or kernel(s), and the model 108 of the system 100 can be updated based at least on the comparison results and/or training performance metrics. For example, based at least on an output of the comparison between predicted and actual operational states, one or more parameters (e.g., weights and/or biases) of the model 108 can be updated.

Additionally, the model 108 can be configured using performance feedback data obtained from the at least one monitor. That is, the performance feedback data can be observed metrics, such as temperature, utilization, or energy consumption, collected during system operation (e.g., in real-time or near real-time). In some implementations, the at least one monitor (e.g., of the component(s) 102) can provide and/or otherwise communicate the performance feedback data by writing data to kernel-level data structures accessible by the model 108 via the interface 106. The performance feedback data can be provided, for example, when a deviation between predicted and observed operational metrics is detected. In some examples, the performance feedback data can be provided when a system event, such as a workload spike or thermal anomaly, is identified by at least one monitor. In some implementations, the model 108 can be updated using the performance feedback data by adjusting the parameters of its layers to improve forecasting accuracy. For example, the system 100 can update the model 108 by applying backpropagation techniques to modify weights and biases based on feedback metrics.

In some implementations, the scheduling stage can be the stage in the resource management pipeline in which the system 100 can allocate processing tasks, modify system parameters, or manage thermal conditions of the components 102 based on predicted states. The system 100 can include at least one scheduler 110. The scheduler 110 can update, according to the predicted state, resource management of the at least one processing unit for execution of a processing task (e.g., resource management operations) by the at least one processing unit. Resource management can be referred to generally as any task scheduling, thermal management, and/or power optimization or improvement action related to dynamic adjustments of component parameters (e.g., in real-time or near real-time and/or during runtime). That is, the scheduler 110 can use the interface 106 to interface with the kernel 104 and/or directly with the component(s) 102 to update component parameters based on operational metrics and model outputs (e.g., of the model(s) 108). For example, the scheduler 110 can use a kernel level interface (e.g., a Netlink socket, IOCTL interface) of the kernel 104 to transmit parameter updates or receive real-time operational data from kernel-managed data structures. In another example, the scheduler 110 can adjust GPU workload distribution to maintain system performance while avoiding thermal thresholds. That is, during the scheduling stage the scheduler 110 can coordinate and/or otherwise manage resource management actions based on predicted operational states to prevent performance bottlenecks, overheating, power overdraw, and/or any system instabilities caused by exceeding operational thresholds.

In some implementations, the scheduler 110 can establish at least one real-time (or near real-time) communication channel with at least one kernel component of the kernel 104 via a kernel level interface (e.g., the interface 106). That is, the scheduler 110 can use at least one communication protocol (e.g., Netlink sockets, IOCTL, sysfs entries, shared memory buffers, inter-process communication (IPC), and/or any low-latency communication methods) with the kernel level interface to transmit at least one parameter (e.g., operational metric and/or system parameters) between a user space and kernel space. The user space can be referred to as the execution environment of processes and applications that interact with the kernel 104 through interfaces or APIs. The kernel space can be referred to as the privileged execution environment of the kernel 104 and its components responsible for managing hardware resources (e.g., the components 102) and low-level system operations.

In some implementations, the scheduler 110 can perform real-time communication with the kernel 104 based at least on the real-time communication occurring within a predefined time window (e.g., updates (e.g., adjusting GPU power levels, allocating GPU tasks, modifying cooling settings) occurring within a fixed period, such as, but not limited to, 1000 ns, 1 ms, 10 ms, 100 ms, and/or any timing interval) to synchronously update the at least one parameter. Additionally, the scheduler 110 can update the resource management on the at least one kernel component (e.g., the kernel 104) to cause an update of the at least one parameter before a component threshold is satisfied (e.g., thermal limit, power consumption limit, processing capacity, clock speed limit). That is, the scheduler 110 performs the update by preemptively modifying component parameters to avoid exceeding thresholds and provide stable system performance.

In some implementations, updating the resource management can include the scheduler 110 performing and/or otherwise facilitating the execution of a thermal management task (e.g., on-the-fly adjustment of cooling system parameters such as, but not limited to, fan speed, liquid cooling rate, airflow direction, dynamic cooling zones, and/or any configurable thermal system parameters) on at least one cooling system of the system 100 based at least on the predicted state of the at least one processing unit (e.g., the component(s) 102). For example, if the model 108 predicts the GPU is going to reach a high temperature due to increased workload, the scheduler 110 can increase the fan speed or liquid cooling rate by sending control signals to the cooling system through the kernel level interface.

In some implementations, updating the resource management can include the scheduler 110 allocating and/or otherwise facilitating the execution of the processing task (e.g., on-the-fly allocation of processing tasks such as, but not limited to, GPU workload distribution (e.g., iGPU and dGPU), CPU thread allocation, memory block usage, network bandwidth reservation) on the at least one processing unit of the system 100 based at least on the predicted state of the at least one processing unit (e.g., the component(s) 102). For example, if the model 108 predicts a spike in iGPU demand, the scheduler 110 can redistribute tasks between GPUs (e.g., iGPU and dGPU), to the CPU, and/or delay execution of certain tasks by modifying task queues or priority levels.

In some implementations, updating the resource management can include the scheduler 110 performing and/or otherwise facilitating the execution of a power management task (e.g., on-the-fly adjustment of power management system such as, but not limited to, power states, energy modes, voltage regulation, dynamic frequency scaling) on at least one power management system of the system 100 based at least on the predicted state of the at least one processing unit (e.g., the component(s) 102). For example, if the model 108 predicts the CPU will enter a low-activity state, the scheduler 110 can modify the power management to reduce power consumption by transitioning to a low power state or disable unused cores by sending power management commands through the kernel interface.

In some implementations, the scheduler 110 can update a resource management by updating at least one static data structure corresponding with a hardware configuration of the at least one processing unit. That is, the static data structure can be device tree blocks (DTBs) corresponding with system parameters (e.g., GPU frequencies, voltage levels, and power states). The static data structure can be updated such that on-the-fly adjustments (e.g., without having to restart, dynamic reconfiguration during runtime, kernel module updates) can be performed by the scheduler 110. For example, the scheduler 110 can modify the DTBs to reflect updated power and performance configurations, such as allocating additional power to a GPU during peak workload periods. In some implementations, the scheduler 110 can update the resource management and execute the processing task during runtime of the system 100. That is, the scheduler 110 can apply updates dynamically without requiring system downtime by leveraging runtime kernel operations and user-space interaction through the interface 106.

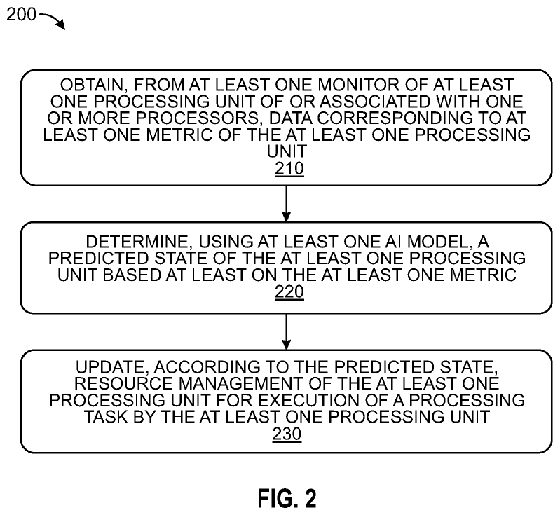

With reference to FIG. 2, an example flow diagram illustrating a method for multi-object tracking in a resource management pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 3A-3C), one or more computing devices or components thereof (e.g., as described in FIG. 4), and/or one or more data centers or components thereof (e.g., as described in FIG. 5).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram depicting a method 200 for obtaining, determining, and updating operations, in accordance with some implementations of the present disclosure. Various operations of method 200 can relate to improving the performance of multi-component resource management systems. Existing systems rely on static configurations and predefined thresholds for resource allocation and thermal management. This approach is inefficient, where the system cannot adapt to real-time workload variations or operational demands. As a result, the resource utilization is inefficient and/or imbalanced, and the systems exhibit latency and inefficiency in task scheduling and thermal regulation to prevent performance degradation or overheating. Method 200 of FIG. 2 can solve these technological problems by implementing at least one model (e.g., autoencoder) with real-time (or near real-time) operational metric processing, predictive modeling of operational states, and/or dynamic parameter updates, which can improve energy efficiency, thermal stability, and/or overall system performance.

The method 200, at block 210, includes obtaining data corresponding to at least one metric (e.g., operational parameters measuring the state or behavior of components) of the at least one processing unit. In some implementations, the one or more processors can monitor at least one processing unit of or associated with the one or more processors. Additionally, responsive to monitoring, the one or more processors can obtain data corresponding to at least one metric of the at least one processing unit. In some implementations, the one or more processors can obtain, using at least one artificial intelligence (AI) model, data from at least one monitor of at least one processing unit of or associated with the one or more processors (e.g., the data corresponding to at least one metric of the at least one processing unit). That is, the one or more processors can obtain the data corresponding with the at least one metric using at least one artificial intelligence (AI) model for input into the AI and/or ML model. For example, the AI and/or ML model (e.g., VAE and/or other machine-learning models) can be used to query operational data, such as thermal or power metrics, directly from kernel-level monitoring interfaces or device sensors. The data corresponding with the at least one metric can be obtained and/or otherwise collected or received from at least one monitor (e.g., monitor devices or sensors) of at least one processing unit (e.g., CPU, GPU (e.g., iGPU, dGPU), memory units, network interface) of or associated with the one or more processors. Additionally, the at least one metric can be one or more operational parameters measuring a state or behavior of the components. For example, an operation parameter can be, but is not limited to, temperature, power draw, utilization, clock speed, latency, workload distribution, processing efficiency, error rates, fault tolerance, and/or any additional diagnostic metric. In some implementations, the data can be obtained in real-time or near real-time. That is, the processors can retrieve data periodically or on-demand based on operational requirements. In some implementations, the at least one processing unit can include at least one integrated graphics processing unit (iGPU) and at least one discrete graphics processing unit (dGPU).

The method 200, at block 220, includes determining, using the at least one AI and/or ML model (e.g., VAE and/or other machine-learning models), a predicted state of the at least one processing unit based at least on the at least one metric. That is, the at least one metric can be applied as input to the AI and/or ML model to cause the AI and/or ML model to generate a predicted state. The predicted state can be a future state (e.g., and without limitation, at a time subsequent to the generation of the predicted state, is the component expected to overheat, enter a high-power state, experience performance throttling). In some implementations, the predicted state of the at least one processing unit can include forecasting a future state (e.g., forecasting an operational state of a system component before a condition occurs) prior to satisfying a condition (e.g., temperature threshold, high power consumption, performance bottleneck). That is, forecasting can occur by the one or more processors determining the predicted state comprises identifying a potential event (e.g., thermal overload, power overdraw) or workload spike (e.g., sudden GPU demand, memory/CPU usage surge) of the at least one processing unit.

In some implementations, the at least one VAE and/or machine-learning model can be trained and/or implemented to process the at least one metric corresponding to at least one of a performance requirement (e.g., minimum task completion time, required processing bandwidth, real-time rendering speed), thermal condition (e.g., ambient temperature, thermal capacity of cooling systems, thermal thresholds for GPU or CPU), or energy consumption (e.g., current power draw, power efficiency thresholds, dynamic energy modes) of the at least one processing unit as input to cause the at least one AI and/or ML model to output the predicted state. For example, power consumption metrics (e.g., energy draw per task) and the corresponding performance requirement (e.g., task deadline) can be applied as input to the VAE to cause the VAE to model and output a predicted state of resource bottlenecks during execution. For example, temperature metrics (e.g., current GPU heat levels) and the corresponding thermal condition (e.g., cooling system efficiency) can be applied as input to the VAE to cause the VAE to model and output a predicted state of potential overheating or thermal throttling scenarios. For example, utilization metrics (e.g., active cores, processing efficiency) and the corresponding energy consumption (e.g., power per active core) can be applied as input to the VAE to cause the VAE to model and output a predicted state of power optimization opportunities during low workload periods. That is, the VAE (e.g., implemented by the one or more processors) can process real-time operational metrics to predict an operational state of the system components (e.g., CPUs, GPUs).

The method 200, at block 230, includes updating, using and/or according to the predicted state, resource management of the at least one processing unit for execution of a processing task (e.g., resource management operations) by the at least one processing unit. That is, the processing circuits can use the predicted state to update at least one static data structure (e.g., device tree blocks (DTBs), configuration tables, parameter files) corresponding with a hardware configuration (e.g., GPU frequency settings, power states, memory allocation rules) of the at least one processing unit to adjust resource management (e.g., task scheduling, thermal management operations, power allocation) of the at least one processing unit for execution of a processing task by the at least one processing unit. In some implementations, the one or more processors can establish at least one real-time communication channel (e.g., to perform resource and thermal management using real-time or near real-time interactions between the processors and kernel components) with at least one kernel component of a kernel via a kernel level interface. That is, the one or more processors can use at least one communication protocol (e.g., Netlink sockets, sysfs entries, shared memory buffers, IPC frameworks) with the kernel level interface to transmit at least one parameter between a user space and kernel space. Additionally, the one or more processors can perform real-time (or near real-time) communication with the kernel based at least on a real-time communication occurring within a predefined time window to synchronously update the at least one parameter (e.g., updates, such as, but not limited to, adjusting GPU power levels, allocating GPU tasks, modifying cooling settings), occur within a fixed period).

In some implementations, the one or more processors can update (e.g., train, re-train, tune) the at least one AI and/or ML model using performance feedback data (e.g., temperature readings over time, power consumption trends during workload execution, task completion latencies) obtained from the at least one monitor. Additionally, the at least one AI and/or ML model can include a variational autoencoder (VAE). Additionally, updating the resource management can include allocating a plurality of processing tasks between the iGPU and the dGPU based on the predicted state of the at least one processing unit. That is, the processing circuits can adjust tasks between the iGPU and dGPU (e.g., not based on predefined rules). In some implementations, the one or more processors can update the resource management on the at least one kernel component to cause an update of the at least one parameter before a component threshold (e.g., thermal limit, power consumption limit, processing capacity, clock speed limit) is satisfied. For example, the one or more processors can update cooling system parameters dynamically based on the thermal condition predicted by the AI and/or ML model. In this example, parameters such as fan speed or cooling fluid rates can be modified to mitigate the risk of overheating during high workload spikes.

In some implementations, the one or more processors can update the resource management by performing a thermal management task on at least one cooling system of the system based at least on the predicted state of the at least one processing unit. That is, the one or more processors can perform on-the-fly adjustment of cooling system parameters (e.g., fan speed, liquid cooling rate). For example, if the VAE predicts the GPU is going to reach a high temperature due to increased workload, the one or more processors can increase the fan speed or liquid cooling rate. In some implementations, the one or more processors can update the resource management by allocating the processing task on the at least one processing unit of the system based at least on the predicted state of the at least one processing unit. In some implementations, the one or more processors can update the resource management by performing a power management task on at least one power management system of the system based at least on the predicted state of the at least one processing unit. That is, the one or more processors can perform on-the-fly adjustment of power management system (e.g., power states, energy modes). For example, if the VAE predicts the CPU will enter a low-activity state, the one or more processors can modify the power management to reduce power consumption by transiting to a low power state or disable unused cores.

In some implementations, updating the resource management comprises updating at least one static data structure corresponding with a hardware configuration of the at least one processing unit. That is, the static data structure can be device tree blocks (DTBs). Additionally, the static data structure can be updated to facilitate a change or update in one or more system parameters (e.g., GPU frequencies, voltage levels, and power states) on the fly (e.g., without having to restart). In some implementations, the one or more processors can update the resource management and execute the processing task during runtime of the one or more processors.

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some implementations, language models, such as large language models (LLMs), small language models (SLMs), vision language models (VLMs), multi-modal language models (MMLMs), and/or other types of generative artificial intelligence (AI) can be implemented. Generally, the language models can process operational data (e.g., metrics such as thermal conditions, workload distribution, energy consumption) to generate outputs that assist in determining predicted operational states and updating system parameters in real-time or near real-time. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases)-such as millions or billions of parameters. The LLMs/SLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures can be implemented in various implementations. For example, different architectures can be implemented that use different techniques for understanding and generating outputs-such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) can be used, while in other implementations transformer architectures-such as those that rely on self-attention and/or cross-attention (e.g., between contextual data and textual data) mechanisms-can be used to understand and recognize relationships between words or tokens and/or contextual data (e.g., other text, video, image, design data, USD, etc.). One or more generative processing pipelines that include LLMs/SLMs/VLMs/MMLMs/etc. can also include one or more diffusion block(s) (e.g., denoisers). The LLMs/SLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/SLMs/VLMs/MMLMs/etc. that include both encoder and decoder components like T5 (Text-to-Text Transformer) can be implemented to understand and generate content, such as for translation and summarization. These examples are not intended to be limiting, and any architecture type-including but not limited to those described herein-can be implemented depending on the particular implementation and the task(s) being performed using the LLMs/SLMs/VLMs/MMLMs/etc.

In various implementations, the LLMs/SLMs/VLMs/MMLMs/etc. can be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/SLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/SLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/SLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models-or layers thereof-can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/SLMs/VLMs/MMLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated-e.g., recursively-for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources-such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents-e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.-as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model-or version, instance, or agent-can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 3A is a block diagram of an example generative language model system 300 suitable for use in implementing at least some implementations of the present disclosure. Generally, the example generative language model system 300 can process input data (e.g., operational metrics, resource allocation parameters) to generate structured outputs for managing system resources, predicting operational states, and updating system parameters in real-time or near real-time. In the example illustrated in FIG. 3A, the generative language model system 300 includes a retrieval augmented generation (RAG) component 392, an input processor 305, a tokenizer 310, an embedding component 320, plug-ins/APIs 395, and a generative language model (LM) 330 (which can include an LLM, a SLM, a VLM, a multi-modal LM, etc.).

At a high level, the input processor 305 can receive an input 301 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 330 (e.g., LLM/SLMs/VLM/MMLM/etc.). In some implementations, the input 301 includes plain text in the form of one or more sentences, paragraphs, and/or documents. Additionally, or alternatively, the input 301 can include numerical sequences, precomputed embeddings (e.g., word or sentence embeddings), and/or structured data (e.g., in tabular formats, JSON, or XML). In some implementations in which the generative LM 330 is capable of processing multi-modal inputs, the input 301 can combine text (or can omit text) with image data, audio data, video data, design data, USD data, and/or other types of input data, such as but not limited to those described herein. Taking raw input text as an example, the input processor 305 can prepare raw input text in various ways. For example, the input processor 305 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 305 can remove stopwords to reduce noise and focus the generative LM 330 on more meaningful content. The input processor 305 can apply text normalization, for example, by converting all characters to lowercase, removing accents, and/or or handling special cases like contractions or abbreviations to ensure consistency. These are just a few examples, and other types of input processing can be applied.

In some implementations, a RAG component 392 (which can include one or more RAG models, and/or can be performed using the generative LM 330 itself) can be used to retrieve additional information to be used as part of the input 301 or prompt. RAG can be used to enhance the input to the LLM/SLMs/VLM/MMLM/etc. with external knowledge, so that answers to specific questions or queries or requests are more relevant-such as in a case where specific knowledge is required. The RAG component 392 can fetch this additional information (e.g., grounding information, such as grounding text/image/video/audio/USD/CAD/etc.) from one or more external sources, which can then be fed to the LLM/SLMs/VLM/MMLM/etc. along with the prompt to improve accuracy of the responses or outputs of the model.

For example, in some implementations, the input 301 can be generated using the query or input to the model (e.g., a question, a request, etc.) in addition to data retrieved using the RAG component 392. In some implementations, the input processor 305 can analyze the input 301 and communicate with the RAG component 392 (or the RAG component 392 can be part of the input processor 305, in implementations) in order to identify relevant text and/or other data to provide to the generative LM 330 as additional context or sources of information from which to identify the response, answer, or output 390, generally. For example, where the input indicates that the user is interested in a desired tire pressure for a particular make and model of vehicle, the RAG component 392 can retrieve-using a RAG model performing a vector search in an embedding space, for example-the tire pressure information or the text corresponding thereto from a digital (embedded) version of the user manual for that particular vehicle make and model. Similarly, where a user revisits a chatbot related to a particular product offering or service, the RAG component 392 can retrieve a prior stored conversation history-or at least a summary thereof-and include the prior conversation history along with the current ask/request as part of the input 301 to the generative LM 330.

The RAG component 392 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 392 and the embeddings of the chunks along with the embeddings of the query can be compared to identify the most similar/related embeddings to the query, which can be supplied to the generative LM 330 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/SLMs/VLM/MMLM/etc. Rather than (or in addition to) providing the model with chunks of data extracted from larger sized documents-which can result in a lack of context, factual correctness, language accuracy, etc.-graph RAG can also provide structured entity information to the LLM/SLMs/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLMs/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/SLMs/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 392 can implement a plugin, API, user interface, and/or other functionality to perform RAG. For example, a graph RAG plug-in can be used by the LLM/SLMs/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 310 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 330 to understand morphological variations and handle out-of-vocabulary words more effectively. Character-based tokenization represents each character as a separate token, enabling the generative LM 330 to process text at a fine-grained level. The choice of tokenization strategy can depend on factors such as the language being processed, the task at hand, and/or characteristics of the training dataset. As such, the tokenizer 310 can convert the (e.g., processed) text into a structured format according to tokenization schema being implemented in the particular implementation.

The embedding component 320 can use any known embedding technique to transform discrete tokens into (e.g., dense, continuous vector) representations of semantic meaning. For example, the embedding component 320 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 301 includes image data/video data/etc., the input processor 301 can resize the data to a standard size compatible with format of a corresponding input channel and/or can normalize pixel values to a common range (e.g., 0 to 1) to ensure a consistent representation, and the embedding component 320 can encode the image data using any known technique (e.g., using one or more convolutional neural networks (CNNs) to extract visual features). In some implementations in which the input 301 includes audio data, the input processor 301 can resample an audio file to a consistent sampling rate for uniform processing, and the embedding component 320 can use any known technique to extract and encode audio features-such as in the form of a spectrogram (e.g., a mel-spectrogram). In some implementations in which the input 301 includes video data, the input processor 301 can extract frames or apply resizing to extracted frames, and the embedding component 320 can extract features such as optical flow embeddings or video embeddings and/or can encode temporal information or sequences of frames. In some implementations in which the input 301 includes multi-modal data, the embedding component 320 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 330 and/or other components of the generative LM system 300 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 320 can apply an encoded representation of the input 301 to the generative LM 330, and the generative LM 330 can process the encoded representation of the input 301 to generate an output 390, which can include responsive text and/or other types of data.

As described herein, in some implementations, the generative LM 330 can be configured to access or use-or capable of accessing or using-plug-ins/APIs 395 (which can include one or more plug-ins, application programming interfaces (APIs), databases, data stores, repositories, etc.). For example, for certain tasks or operations that the generative LM 330 is not ideally suited for, the model can have instructions (e.g., as a result of training, and/or based on instructions in a given prompt, such as those retrieved using the RAG component 392) to access one or more plug-ins/APIs 395 (e.g., 3rd party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 395 to the plug-in/API 395, the plug-in/API 395 can process the information and return an answer to the generative LM 330, and the generative LM 330 can use the response to generate the output 390. This process can be repeated—e.g., recursively—for any number of iterations and using any number of plug-ins/APIs 395 until an output 390 that addresses each ask/question/request/process/operation/etc. from the input 301 can be generated. As such, the model(s) can not only rely on its own knowledge from training on a large dataset(s) and/or from data retrieved using the RAG component 392, but also on the expertise or optimized nature of one or more external resources-such as the plug-ins/APIs 395.

FIG. 3B is a block diagram of an example implementation in which the generative LM 330 includes a transformer encoder-decoder. Generally, the generative LM 330 can process operational data using an encoder-decoder architecture to generate predictions or outputs, such as task allocations, parameter updates, or resource management actions, based on real-time or historical metrics. For example, assume input text such as “Who discovered gravity” is tokenized (e.g., by the tokenizer 310 of FIG. 3A) into tokens such as words, and each token is encoded (e.g., by the embedding component 320 of FIG. 3A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 335 of the generative LM 330.

In an example implementation, the encoder(s) 335 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 340 can convert the context vector into attention vectors (keys and values) for the decoder(s) 345.

In an example implementation, the decoder(s) 345 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 335, in an example transformer architecture, each token (e.g., word) flows through a separate path in the decoder(s) 345. During a first pass, the decoder(s) 345, a classifier 350, and a generation mechanism 355 can generate a first token, and the generation mechanism 355 can apply the generated token as an input during a second pass. The process can repeat in a loop, successively generating and adding tokens (e.g., words) to the output from the preceding pass and applying the token embeddings of the composite sequence with positional encodings as an input to the decoder(s) 345 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 335, except that it creates its queries from the layer below it and takes the keys and values (e.g., matrix) from the output of the encoder(s) 335.

As such, the decoder(s) 345 can output some decoded (e.g., vector) representation of the input being applied during a particular pass. The classifier 350 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 355 can select or sample a word or token based on a corresponding predicted probability (e.g., select the word with the highest predicted probability) and append it to the output from a previous pass, generating each word or token sequentially. The generation mechanism 355 can repeat the process, triggering successive decoder inputs and corresponding predictions until selecting or sampling a symbol or token that represents the end of the response, at which point, the generation mechanism 355 can output the generated response.

FIG. 3C is a block diagram of an example implementation in which the generative LM 330 includes a decoder-only transformer architecture. For example, the decoder(s) 360 of FIG. 3C can operate similarly as the decoder(s) 345 of FIG. 3B except each of the decoder(s) 360 of FIG. 3C omits the encoder-decoder self-attention layer (since there is no encoder in this implementation). As such, the decoder(s) 360 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 360. As with the decoder(s) 345 of FIG. 3B, each token (e.g., word) can flow through a separate path in the decoder(s) 360, and the decoder(s) 360, a classifier 365, and a generation mechanism 370 can use auto-regression to sequentially generate one token at a time until predicting a symbol or token that represents the end of the response. The classifier 365 and the generation mechanism 370 can operate similarly as the classifier 350 and the generation mechanism 355 of FIG. 3B, with the generation mechanism 370 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 4 is a block diagram of an example computing device(s) 400 suitable for use in implementing some implementations of the present disclosure. Generally, the example computing device(s) 400 can execute operations for obtaining operational metrics, predicting operational states, and performing resource management updates, including task scheduling, thermal management, and parameter adjustments in real-time or near real-time. Computing device 400 can include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one implementation, the computing device(s) 400 can comprise one or more virtual machines (VMs), and/or any of the components thereof can comprise virtual components (e.g., virtual hardware components). For non-limiting examples, one or more of the GPUs 408 can comprise one or more vGPUs, one or more of the CPUs 406 can comprise one or more vCPUs, and/or one or more of the logic units 420 can comprise one or more virtual logic units. As such, a computing device(s) 400 can include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some implementations, a presentation component 418, such as a display device, can be considered an I/O component 414 (e.g., if the display is a touch screen). As another example, the CPUs 406 and/or GPUs 408 can include memory (e.g., the memory 404 can be representative of a storage device in addition to the memory of the GPUs 408, the CPUs 406, and/or other components). As such, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 can represent one or more links or busses, such as an address bus, a data bus, a control bus, or a combination thereof. The interconnect system 402 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 406 can be directly connected to the memory 404. Further, the CPU 406 can be directly connected to the GPU 408. Where there is direct, or point-to-point connection between components, the interconnect system 402 can include a PCIe link to carry out the connection. In these examples, a PCI bus need not be included in the computing device 400.

The memory 404 can include any of a variety of computer-readable media. The computer-readable media can be any available media that can be accessed by the computing device 400. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 404 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 400. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 406 can be configured to execute at least some of the computer-readable instructions to control one or more components of the computing device 400 to perform one or more of the methods and/or processes described herein. The CPU(s) 406 can each include one or more cores (e.g., one, two, four, eight, twenty-eight, seventy-two, etc.) that are capable of handling a multitude of software threads simultaneously. The CPU(s) 406 can include any type of processor, and can include different types of processors depending on the type of computing device 400 implemented (e.g., processors with fewer cores for mobile devices and processors with more cores for servers). For example, depending on the type of computing device 400, the processor can be an Advanced RISC Machines (ARM) processor implemented using Reduced Instruction Set Computing (RISC) or an x86 processor implemented using Complex Instruction Set Computing (CISC). The computing device 400 can include one or more CPUs 406 in addition to one or more microprocessors or supplementary co-processors, such as math co-processors.

In addition to or alternatively from the CPU(s) 406, the GPU(s) 408 can be configured to execute at least some of the computer-readable instructions to control one or more components of the computing device 400 to perform one or more of the methods and/or processes described herein. One or more of the GPU(s) 408 can be an integrated GPU (e.g., with one or more of the CPU(s) 406 and/or one or more of the GPU(s) 408 can be a discrete GPU. In implementations, one or more of the GPU(s) 408 can be a coprocessor of one or more of the CPU(s) 406. The GPU(s) 408 can be used by the computing device 400 to render graphics (e.g., 3D graphics) or perform general purpose computations. For example, the GPU(s) 408 can be used for General-Purpose computing on GPUs (GPGPU). The GPU(s) 408 can include hundreds or thousands of cores that are capable of handling hundreds or thousands of software threads simultaneously. The GPU(s) 408 can generate pixel data for output images in response to rendering commands (e.g., rendering commands from the CPU(s) 406 received via a host interface). The GPU(s) 408 can include graphics memory, such as display memory, for storing pixel data or any other suitable data, such as GPGPU data. The display memory can be included as part of the memory 404. The GPU(s) 408 can include two or more GPUs operating in parallel (e.g., via a link). The link can directly connect the GPUs (e.g., using NVLINK) or can connect the GPUs through a switch (e.g., using NVSwitch). When combined together, each GPU 408 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 406 and/or the GPU(s) 408, the logic unit(s) 420 can be configured to execute at least some of the computer-readable instructions to control one or more components of the computing device 400 to perform one or more of the methods and/or processes described herein. In implementations, the CPU(s) 406, the GPU(s) 408, and/or the logic unit(s) 420 can discretely or jointly perform any combination of the methods, processes and/or portions thereof. One or more of the logic units 420 can be part of and/or integrated in one or more of the CPU(s) 406 and/or the GPU(s) 408 and/or one or more of the logic units 420 can be discrete components or otherwise external to the CPU(s) 406 and/or the GPU(s) 408. In implementations, one or more of the logic units 420 can be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)-which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 can include one or more receivers, transmitters, and/or transceivers that allow the computing device 400 to communicate with other computing devices via an electronic communication network, included wired and/or wireless communications. The communication interface 410 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 420 and/or communication interface 410 can include one or more data processing units (DPUs) to transmit data received over a network and/or through interconnect system 402 directly to (e.g., a memory of) one or more GPU(s) 408.

The I/O ports 412 can allow the computing device 400 to be logically coupled to other devices including the I/O components 414, the presentation component(s) 418, and/or other components, some of which can be built in to (e.g., integrated in) the computing device 400. Illustrative I/O components 414 include a microphone, mouse, keyboard, joystick, game pad, game controller, satellite dish, scanner, printer, wireless device, etc. The I/O components 414 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 can be include depth cameras, such as stereoscopic camera systems, infrared camera systems, RGB camera systems, touchscreen technology, and combinations of these, for gesture detection and recognition. Additionally, the computing device 400 can include accelerometers or gyroscopes (e.g., as part of an inertia measurement unit (IMU)) that allow detection of motion. In some examples, the output of the accelerometers or gyroscopes can be used by the computing device 400 to render immersive augmented reality or virtual reality.

The power supply 416 can include a hard-wired power supply, a battery power supply, or a combination thereof. The power supply 416 can provide power to the computing device 400 to allow the components of the computing device 400 to operate.

The presentation component(s) 418 can include a display (e.g., a monitor, a touch screen, a television screen, a heads-up-display (HUD), other display types, or a combination thereof), speakers, and/or other presentation components. The presentation component(s) 418 can receive data from other components (e.g., the GPU(s) 408, the CPU(s) 406, DPUs, etc.), and output the data (e.g., as an image, video, sound, etc.).

### Example Data Center

FIG. 5 illustrates an example data center 500 that can be used in at least one implementations of the present disclosure. Generally, the example data center 500 can host computing resources for executing operations such as obtaining operational metrics, predicting operational states, and managing system parameters across multiple systems, including resource allocation, thermal management, and power optimization, in real-time or near real-time. The data center 500 can include a data center infrastructure layer 510, a framework layer 520, a software layer 530, and/or an application layer 540.

As shown in FIG. 5, the data center infrastructure layer 510 can include a resource orchestrator 512, grouped computing resources 514, and node computing resources (“node C.R.s”) 516(1)-516(N), where “N” represents any whole, positive integer. In at least one implementation, node C.R.s 516(1)-516(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 516(1)-516(N) can correspond to a server having one or more of the above-mentioned computing resources. In addition, in some implementations, the node C.R.s 516(1)-5161(N) can include one or more virtual components, such as vGPUs, vCPUs, and/or the like, and/or one or more of the node C.R.s 516(1)-516(N) can correspond to a virtual machine (VM).

In at least one implementation, grouped computing resources 514 can include separate groupings of node C.R.s 516 housed within one or more racks (not shown), or many racks housed in data centers at various geographical locations (also not shown). Separate groupings of node C.R.s 516 within grouped computing resources 514 can include grouped compute, network, memory or storage resources that can be configured or allocated to support one or more workloads. In at least one implementation, several node C.R.s 516 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 512 can configure or otherwise control one or more node C.R.s 516(1)-516(N) and/or grouped computing resources 514. In at least one implementation, resource orchestrator 512 can include a software design infrastructure (SDI) management entity for the data center 500. The resource orchestrator 512 can include hardware, software, or some combination thereof.

In at least one implementation, as shown in FIG. 5, framework layer 520 can include a job scheduler 528, a configuration manager 534, a resource manager 536, and/or a distributed file system 538. The framework layer 520 can include a framework to support software 532 of software layer 530 and/or one or more application(s) 542 of application layer 540. The software 532 or application(s) 542 can respectively include web-based service software or applications, such as those provided by Amazon Web Services, Google Cloud and Microsoft Azure. The framework layer 520 can be, but is not limited to, a type of free and open-source software web application framework such as Apache Spark™(hereinafter “Spark”) that can use distributed file system 538 for large-scale data processing (e.g., “big data”). In at least one implementation, job scheduler 528 can include a Spark driver to facilitate scheduling of workloads supported by various layers of data center 500. The configuration manager 534 can be capable of configuring different layers such as software layer 530 and framework layer 520 including Spark and distributed file system 538 for supporting large-scale data processing. The resource manager 536 can be capable of managing clustered or grouped computing resources mapped to or allocated for support of distributed file system 538 and job scheduler 528. In at least one implementation, clustered or grouped computing resources can include grouped computing resource 514 at data center infrastructure layer 510. The resource manager 536 can coordinate with resource orchestrator 512 to manage these mapped or allocated computing resources.

In at least one implementation, software 532 included in software layer 530 can include software used by at least portions of node C.R.s 516(1)-516(N), grouped computing resources 514, and/or distributed file system 538 of framework layer 520. One or more types of software can include, but are not limited to, Internet web page search software, e-mail virus scan software, database software, and streaming video content software.

In at least one implementation, application(s) 542 included in application layer 540 can include one or more types of applications used by at least portions of node C.R.s 516(1)-516(N), grouped computing resources 514, and/or distributed file system 538 of framework layer 520. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 534, resource manager 536, and resource orchestrator 512 can implement any number and type of self-modifying actions based on any amount and type of data acquired in any technically feasible fashion. Self-modifying actions can relieve a data center operator of data center 500 from making possibly bad configuration decisions and possibly avoiding underutilized and/or poor performing portions of a data center.

The data center 500 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 500. In at least one implementation, trained or deployed machine learning models corresponding to one or more neural networks can be used to infer or predict information using resources described above with respect to the data center 500 by using weight parameters calculated through one or more training techniques, such as but not limited to those described herein.

In at least one implementation, the data center 500 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 400 of FIG. 4-e.g., each device can include similar components, features, and/or functionality of the computing device(s) 400. In addition, where backend devices (e.g., servers, NAS, etc.) are implemented, the backend devices can be included as part of a data center 500, an example of which is described in more detail herein with respect to FIG. 5.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments-in which case a server cannot be included in a network environment-and one or more client-server network environments-in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 400 described herein with respect to FIG. 4. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. A system, comprising:
one or more processors to:
obtain, from at least one monitor of at least one processing unit of or associated with the one or more processors, data corresponding to at least one metric of the at least one processing unit;
determine, using at least one artificial intelligence (AI) model, a predicted state of the at least one processing unit based at least on the at least one metric; and
update, using the predicted state, at least one static data structure corresponding with a hardware configuration of the at least one processing unit to adjust resource management of the at least one processing unit for execution of a processing task by the at least one processing unit.

2. The system of claim 1, wherein the at least one processing unit comprises at least one integrated graphics processing unit (iGPU) and at least one discrete graphics processing unit (dGPU), and updating the resource management comprises allocating a plurality of processing tasks between the iGPU and the dGPU based on the predicted state of the at least one processing unit.

3. The system of claim 1, wherein the one or more processors are to update the at least one AI model using performance feedback data obtained from the at least one monitor, and wherein the at least one AI model comprises a variational autoencoder (VAE).

4. The system of claim 1, wherein the one or more processors are to:
establish at least on real-time communication channel with at least one kernel component of a kernel via a kernel level interface;
use at least one communication protocol with the kernel level interface to transmit at least one parameter between a user space and kernel space; and
perform real-time communication with the kernel based at least on the real-time communication occurring within a predefined time window to synchronously update the at least one parameter.

5. The system of claim 4, wherein the one or more processors are to update the resource management on the at least one kernel component to cause an update of the at least one parameter before a component threshold is satisfied.

6. The system of claim 4, wherein the one or more processors are to update the resource management by at least one of:
performing a thermal management task on at least one cooling system of the system based at least on the predicted state of the at least one processing unit;
allocating the processing task on the at least one processing unit of the system based at least on the predicted state of the at least one processing unit; or
performing a power management task on at least one power management system of the system based at least on the predicted state of the at least one processing unit.

7. The system of claim 1, wherein updating the resource management comprises updating the at least one static data structure, and wherein the one or more processors are to update the resource management and execute the processing task during runtime of the system.

8. The system of claim 1, wherein the predicted state of the at least one processing unit comprises forecasting a future state prior to satisfying a condition, and wherein forecasting the future state comprises identifying a potential event or workload spike of the at least one processing unit.

9. The system of claim 1, wherein the at least one AI model is configured to process the at least one metric corresponding to at least one of a performance requirement, thermal condition, or energy consumption of the at least one processing unit as input to cause the at least one AI model to output the predicted state.

10. The system of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

11. One or more processors, comprising:
one or more circuits to:
monitor at least one processing unit of or associated with the one or more processors;
responsive to monitoring, obtain data corresponding to at least one metric of the at least one processing unit;
determine, using at least one artificial intelligence (AI) model, a predicted state of the at least one processing unit based at least on the at least one metric; and
update, according to the predicted state, resource management of the at least one processing unit for execution of a processing task by the at least one processing unit.

12. The one or more processors of claim 11, wherein the at least one processing unit comprises at least one integrated graphics processing unit (iGPU) and at least one discrete graphics processing unit (dGPU), and updating the resource management comprises allocating a plurality of processing tasks between the iGPU and the dGPU based on the predicted state of the at least one processing unit.

13. The one or more processors of claim 11, wherein the one or more circuits are to update the at least one AI model using performance feedback data obtained from at least one monitor, and wherein the at least one AI model comprises a variational autoencoder (VAE).

14. The one or more processors of claim 11, wherein the one or more circuits are to:
establish at least on real-time communication channel with at least one kernel component of a kernel via a kernel level interface;
use at least one communication protocol with the kernel level interface to transmit at least one parameter between a user space and kernel space; and
perform real-time communication with the kernel based at least one the real-time communication occurring within a predefined time window to synchronously update the at least one parameter.

15. The one or more processors of claim 14, wherein the one or more circuits are to update the resource management on the at least one kernel component to cause an update of the at least one parameter before a component threshold is satisfied.

16. The one or more processors of claim 14, wherein the one or more circuits are to update the resource management by at least one of:
performing a thermal management task on at least one cooling system of the one or more processors based at least on the predicted state of the at least one processing unit;
allocating the processing task on the at least one processing unit of the one or more processors based at least on the predicted state of the at least one processing unit; or
performing a power management task on at least one power management system of the one or more processors based at least on the predicted state of the at least one processing unit.

17. The one or more processors of claim 11, wherein updating the resource management comprises updating at least one static data structure corresponding with a hardware configuration of the at least one processing unit, and wherein the one or more circuits are to update the resource management and execute the processing task during runtime of the one or more processors.

18. The one or more processors of claim 11, wherein the predicted state of the at least one processing unit comprises forecasting a future state prior to satisfying a condition, and wherein forecasting the future state comprises identifying a potential event or workload spike of the at least one processing unit.

19. The one or more processors of claim 11, wherein the at least one AI model is configured to process the at least one metric corresponding to at least one of a performance requirement, thermal condition, or energy consumption of the at least one processing unit as input to cause the at least one AI model to output the predicted state.

20. A method, comprising:
obtaining, by one or more processors using at least one artificial intelligence (AI) model, data from at least one monitor of at least one processing unit of or associated with the one or more processors, the data corresponding to at least one metric of the at least one processing unit;
determining, by the one or more processors using the at least one AI model, a predicted state of the at least one processing unit based at least on the at least one metric; and
updating, by the one or more processors according to the predicted state, resource management of the at least one processing unit for execution of a processing task by the at least one processing unit.
